(19) United States
(12) Patent Application Publication
(10) Pub. No.: US 2016/0211499 A1
(43) Pub. Date: Jul. 21, 2016

(54) BATTERY MODULE

(71) Applicant: SAMSUNG SDI CO., LTD., Yongin-si (KR)

(72) Inventor: Susang CHO, Yongin-si (KR)

(21) Appl. No.: 14/723,789

(22) Filed: May 28, 2015

(30) Foreign Application Priority Data
Jan. 19, 2015 (KR) 10-2015-0008672

(51) Int. Cl. H01M 2/20; H01M 2/10

(52) U.S. Cl. CPC H01M 2/202; H01M 2/204; H01M 2/206; H01M 2/1016; H01M 2/1022; H01M 2/1072; H01M 2220/30; H01M 2220/20

(57) ABSTRACT

A battery module, including a plurality of battery cells connected in series or in parallel to each other, each battery cell including an electrode tab exposed at one side of the battery cell; a holder fixing the plurality of battery cells; a connection plate having a first side electrically connected to the electrode tab of at least one of the battery cells, the connection plate mounted on an outer surface of the holder; and an external terminal coupled to a second side of the connection plate.

### CROSS-REFERENCE TO RELATED APPLICATION

Korean Patent Application No. 10-2015-0008672, filed on Jan. 19, 2015, in the Korean Intellectual Property Office, and entitled: “Battery Module,” is incorporated by reference herein in its entirety.

### BACKGROUND

1. Field

Embodiments relate to a battery module.

2. Description of the Related Art

A battery cell may be used as an energy source for, e.g., a mobile device, an electric vehicle, or a hybrid vehicle. The battery cell may be used with various configurations modified according to the kind of external device employed.

### SUMMARY

Embodiments may be realized by providing a battery module, including a plurality of battery cells connected in series or in parallel to each other, each battery cell including an electrode tab exposed at one side of the battery cell; a holder fixing the plurality of battery cells; a connection plate having a first side electrically connected to the electrode tab of at least one of the battery cells, the connection plate mounted on an outer surface of the holder; and an external terminal coupled to a second side of the connection plate.

The plurality of battery cells may be electrically connected to each other through bus bars.

The electrode tab may include a negative electrode tab and a positive electrode tab, and the connection plate may include a first connection plate electrically connected to the negative electrode tab and a second connection plate electrically connected to the positive electrode tab.

A distance between the first connection plate and the second connection plate may be 5.0 mm or greater.

The connection plate may have a width of 10 mm or greater.

The connection plate may have a thickness in a range of 0.3 mm to 0.5 mm.

The first connection plate or the second connection plate may include a fuse part.

The fuse part may have a width in a range of 15% to 20% of a width of the connection plate.

The second side of the connection plate may be coupled to the external terminal using a bolt.

The second side of the connection plate may include a bent portion.

The holder may include a holder case in which the plurality of battery cells are aligned, and a holder cover coupled to the holder case and covering first surfaces of the plurality of battery cells, the first side of the connection plate may be electrically connected to the electrode tab of at least one of the plurality of battery cells from an outer surface of the holder case, and the connection plate may be mounted on the outer surface of the holder cover.

The outer surface of the holder cover may include guide portions, and the connection plate may be mounted between the guide portions.

The holder cover may include a plurality of ribs downwardly extending from an inner surface of the holder cover, the plurality of ribs being inserted between each of the plurality of battery cells.

Each of the plurality of ribs may have a thickness in a range of 10% to 15% of a thickness of each of the plurality of battery cells.

### BRIEF DESCRIPTION OF THE DRAWINGS

Features will become apparent to those of skill in the art by describing in detail exemplary embodiments with reference to the attached drawings in which:

FIG. 1 illustrates a front perspective view of a battery module according to an embodiment;

FIG. 2 illustrates a rear perspective view of the battery module illustrated in FIG. 1;

FIG. 3 illustrates a front perspective view of a battery module according to an embodiment; and

FIG. 4 illustrates a rear perspective view of a battery module according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

As used herein, the term “and/or” includes any and all combinations of one or more of the associated listed items. The terminology used herein is for the purpose of describing particular embodiments and is not intended to be limiting. As used herein, singular forms are intended to include the plural forms as well, unless the context clearly indicates otherwise. It will be further understood that the terms “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, components, regions, layers and/or sections, these elements, components, regions, layers and/or sections should not be limited by these terms. These terms are only used to distinguish one element, component, region, layer or section from another element, component, region, layer or section.

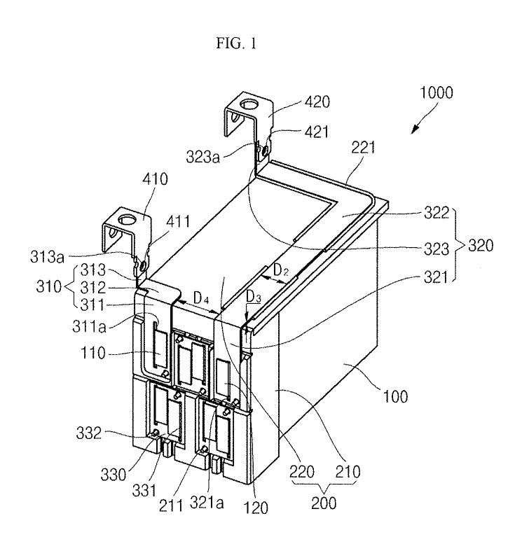

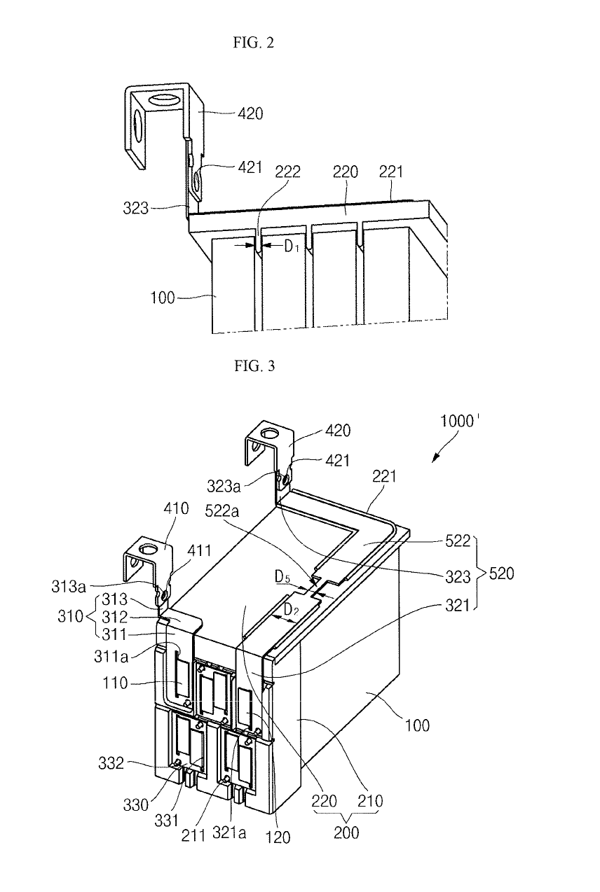

Hereinafter, a battery module according to an embodiment will be described with reference to FIGS. 1 and 2.

FIG. 1 illustrates a front perspective view of a battery module according to an embodiment. FIG. 2 illustrates a rear perspective view of the battery module illustrated in FIG. 1.

Referring to FIGS. 1 and 2, the battery module 1000 according to an embodiment may include a plurality of battery cells 100, holder 200, connection plates 310 and 320, bus bars 330, and external terminals 410 and 420.

The plurality of battery cells 100 may be aligned in and fixed to the holder 200 and may be connected in series and/or in parallel to each other.

Each of the battery cells 100 may include a battery case having an open surface and an electrode assembly and an electrolyte accommodated in the battery case. The electrode assembly and the electrolyte may electrochemically react with each other to generate energy. The battery case may be sealed by one surface of the battery cell 100 including a cap assembly. A negative electrode tab 110 and a positive electrode tab 120 having different polarities may protrude to, e.g., from, one side and may be provided on the one surface of the battery cell 100. Neighboring ones among the plurality of battery cells 100 may be electrically connected through the bus bars 330. The connection plates 310 and 320 may be electrically and physically connected to the negative electrode tab 110 and the positive electrode tab 120 of the outermost battery cell 100, respectively.

The holder 200 may include a holder case 210 into which the plurality of battery cells 100 may be inserted and then fixed, and a holder cover 220 that may be coupled to the holder case 210 and that may cover first surfaces of the plurality of battery cells 100.

Grooves may be formed on an outer surface of the holder case 210, and protrusions 211 may be formed in the grooves to fix first sides of the connection plates 310 and 320 and the bus bars 330 thereto. The negative electrode tab 110 and the positive electrode tab 120 of the battery cell 100 may be electrically/physically connected to the connection plates 310 and 320 or the bus bars 330 on the outer surface of the holder case 210.

The negative electrode tab 110 and the positive electrode tab 120 of the battery cell 100 may be welded and attached to top surfaces of the connection plates 310 and 320 or the bus bars 330 by, for example, resistance welding.

The holder cover 220 may be coupled to one side of the holder case 210 in a bent direction and may cover the first surfaces of the plurality of battery cells 100.

The holder cover 220 may include guide portions 221 formed on its top surface and a plurality of ribs 222 formed on its bottom surface.

The guide portions 221 may be formed to upwardly extend a predetermined height to guide mounting portions of the connection plates 310 and 320. The guide portions 221 may be formed to have shapes of protruding lines or protruding dots.

The plurality of ribs 222 may downwardly extend a predetermined depth and may be inserted between each of the plurality of battery cells 100. The plurality of battery cells 100 may be spaced apart from each other through the plurality of ribs 222 to then be aligned.

Each of the battery cells 100 may have thicknesses increasing from edges to the center of the battery cell during swelling, for example, due to charging and discharging. To cope with swelling of the battery cell 100, each of the ribs 222 may have a thickness D1 in a range of 10% to 15% of a thickness of the battery cell 100.

When the thickness D of each of the ribs 222 is 10% or less of the thickness of each of the battery cells 100, during swelling of the battery cells 100, neighboring battery cells 100 may push each other, which may cause damages to the battery module 1000. When the thickness D of each of the ribs 222 is 15% or greater of the thickness of each of the battery cells 100, neighboring battery cells 100 may be excessively spaced apart from each other, and an increase in the volume of the battery module 1000 may result.

The connection plates 310 and 320 may include a first connection plate 310 electrically connected to the negative electrode tab 110 and a second connection plate 320 electrically connected to the positive electrode tab 120.

Each of the connection plates 310 and 320 may have a width D2 of 10 mm or greater and a thickness D3 in a range of 0.3 mm to 0.5 mm.

When the width D2 of each of the connection plates 310 and 320 is 10 mm or less, the connection plates 310 and 320 may not be able to withstand a high current (e.g., 100A or greater) flowing therethrough. When the thickness D3 of each of the connection plates 310 and 320 is 0.3 mm or less, the connection plates 310 and 320 may not be able to withstand a high current, as described above. When the thickness D3 of each of the connection plates 310 and 320 is 0.5 mm or greater, a volume of the battery module 1000 may excessively increase.

A distance between the first connection plate 310 and the second connection plate 320 may be 5.0 mm or greater.

When the distance between the first connection plate 310 and the second connection plate 320 is 5.0 mm or less, electric short circuits may be generated between the first connection plate 310 and the second connection plate 320, for example, due to a high current flowing through the first connection plate 310 and the second connection plate 320.

The first connection plate 310 may be made of a conductive material selected from aluminum, copper, a copper alloy, and equivalents thereof, and may include a first region 311, a second region 312, and a third region 313.

The first region 311 may be formed at one side, e.g., a first or vertically lower side, of the first connection plate 310 and may be electrically and physically connected to the negative electrode tab 110 on the outer surface of the holder case 210. A slit 311a may be formed in the first region 311 to allow the negative electrode tab 110 to be inserted thereinto.

The negative electrode tab 110 may be bent while passing through the slit 311a and may be welded and fixed to the outer surface of the first region 311 by resistance welding.

The second region 312 may extend from the first region 311 and may be bent to an upper portion of the holder case 220.

The second region 312 may be a region that may be mounted on the outer surface of the holder case 220 and may be mounted between the guide portions 221 to then be fixed, as described above.

The third region 313 may be formed at the other side, e.g., a second or vertically upper side, of the first connection plate 310 and may extend from the second region 312 to then be bent to the external terminal 410.

A coupling hole 313a may be formed in the third region 313 to be coupled to the external terminal 410 using, for example, a bolt.

The second connection plate 320 may be made of a conductive material selected from aluminum, copper, a copper alloy, and equivalents thereof, and may include a first region 321, a second region 322, and a third region 323.

The first region 321 may be formed at one side of the second connection plate 320 and may be electrically and physically connected to the positive electrode tab 120 on the outer surface of the holder case 210. A slit 321a may be formed in the first region 321 to allow the positive electrode tab 120 to be inserted thereinto.

The positive electrode tab 120 may be bent while passing through the slit 321a and may be welded and fixed to the outer surface of the first region 321 by resistance welding.

The second region 322 may extend from the first region 321 and may be bent to an upper portion of the holder case 220.

The second region 322 may be a region that may be mounted on the outer surface of the holder case 220 and may be mounted between the guide portions 221 to then be fixed, as described above.

The third region 323 may be formed at the other side of the second connection plate 320 and may extend from the second region 322 to then be bent to the external terminal 420.

A coupling hole 323a may be formed in the third region 323 to be coupled to the external terminal 420 using, for example, a bolt.

The bus bars 330 may be made of a conductive material selected from aluminum, copper, a copper alloy, and equivalents thereof, and at least two slits 331 may be formed on one surface of each of the bus bars 330 while passing through the one surface. Fixing holes 332 passing through the one surface and allowing the protrusions 211 to be inserted thereinto may be formed on each of the bus bars 330.

The negative electrode tab 110 of one battery cell 100 and the negative electrode tab 110 of a neighboring battery cell 100 may be inserted into the slits 331 of the bus bars 330, respectively. The positive electrode tab 120 of one battery cell 100 and the positive electrode tab 120 of a neighboring battery cell 100 may be inserted into the slits 331 of the bus bars 330, respectively. In the state described herein, the plurality of battery cells 100 are connected in series to each other. In an embodiment, the plurality of battery cells 100 may be connected in parallel to each other through the bus bars 330.

The negative electrode tab 110 and the positive electrode tab 110 may be bent while passing through the slits 331 and may be welded and fixed to the outer surfaces of the bus bars 330 by, for example, resistance welding.

The external terminals 410 and 420 may include a first external terminal 410 having a negative polarity and a second external terminal 420 having a positive polarity.

The first external terminal 410 may be made of a conductive material selected from aluminum, copper, a copper alloy, and equivalents thereof, and may be electrically connected to the negative electrode tab 110 through the first connection plate 310.

A coupling hole 411 may be formed in one side of the first external terminal 410 to then be coupled to the third region 313 of the first connection plate 310 using, for example, a bolt, as described above.

The second external terminal 420 may be made of a conductive material selected from aluminum, copper, a copper alloy, and equivalents thereof, and may be electrically connected to the positive electrode tab 120 through the second connection plate 320.

A coupling hole 421 may be formed in one side of the second external terminal 420 to then be coupled to the third region 323 of the second connection plate 320 using, for example, a bolt, as described above.

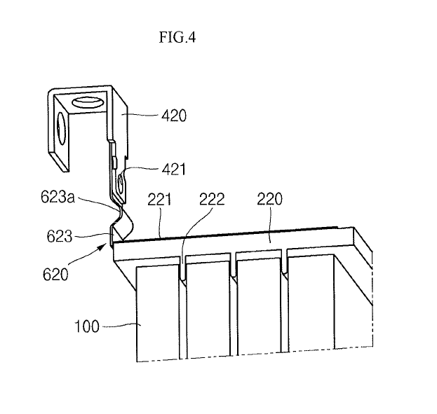

FIG. 3 illustrates a front perspective view of a battery module according to an embodiment.

The battery module 1000′ according to an embodiment may differ from the battery module 1000 illustrated in FIG. 1 with respect to a configuration of a second connection plate 520. In the following description, the battery module 1000′ will be described with regard to the second connection plate 520. Substantially the same components of the battery module 1000′ are denoted by the same reference numerals of the battery module 1000 illustrated in FIG. 1 and detailed descriptions thereof will not be given.

The second connection plate 520 may be made of a conductive material selected from aluminum, copper, a copper alloy, and equivalents thereof, and may include a first region 321, a second region 522, and a third region 323.

The second region 522 may extend from the first region 321 and may be bent to an upper portion of a holder case 220.

The second region 522 may be a region that may be mounted on the outer surface of the holder case 220 and may be mounted between guide portions 221 to then be fixed, as described above.

A fuse part 522a having a smaller thickness D5 than surrounding regions may be formed in a roughly central region of the second region 522.

When an abnormal event, such as an overcharge, occurs to the battery module 1000′, heat may be generated in the second connection plate 520. The generated heat concentrated on the fuse part 522a having a relatively small sectional area and the fuse part 522a may then be fused. The fuse part 522a may be broken, and an electrical connection of the battery module 1000′ may be cut off.

The width D5 of the fuse part 522a may be in a range of 15% to 20% of the width D2 of the second region 522.

When the width D5 of the fuse part 522a is less than 15% of the width D2 of the second region 522, the fuse part 522a may be fused, for example, due to heat concentration, before a critical value preset to the fuse part 522a. When the width D5 of the fuse part 522a is greater than 20% of the width D2 of the second region 522, it may be difficult to rapidly cut off the electrical connection of the battery module 1000′ at the preset critical value.

FIG. 4 illustrates a rear perspective view of a battery module according to an embodiment.

The battery module according to an embodiment may differ from the battery module 1000 illustrated in FIG. 2 with respect to configurations of a first connection plate and a second connection plate 620. In the following description, the battery module 1000 will be described with regard to the second connection plate 620. Substantially the same components of the battery module are denoted by the same reference numerals of the battery module 1000 illustrated in FIG. 2 and detailed descriptions thereof will not be given.

The second connection plate 620 may be made of a conductive material selected from aluminum, copper, a copper alloy, and equivalents thereof, and may include a first region, a second region, and a third region 623.

The third region 623 may be formed at the other side of the second connection plate and may extend from the second region to then be bent to an external terminal 420.

A coupling hole may be formed in the third region 623 to be coupled to the external terminal 420 using, for example, a bolt.

A bent portion 623a bent in a substantially “U” shape may be formed in a roughly central region of the third region 623. The bent portion 623a may protrude in one direction and may be shaped of, e.g., similar to, an arch to provide flexibility when the second external terminal 420 is connected to an external device, and may absorb external shocks and vibrations.

By way of summation and review, a small-sized mobile device, such as a cellular phone, may operate for a predetermined time with output power and capacity of a single battery cell. When a mobile device may need to be driven for a long time with high output power, like an electric vehicle or a hybrid vehicle consuming a large amount of power, to increase output power and capacity, a plurality of battery cells may be electrically connected to constitute a large-capacity battery module. A battery module may have an increased output voltage or current according to the number of battery cells included in the battery module. A plurality of battery modules may be electrically connected to each other, and a battery pack may be formed.

As described above, the battery module according to embodiments may improve manufacturability by shortening a module assembling time. The battery module according to embodiments may save material costs.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells connected in series or in parallel to each other, each battery cell including an electrode tab exposed at one side of the battery cell;
a holder fixing the plurality of battery cells;
a connection plate having a first side electrically connected to the electrode tab of at least one of the battery cells, the connection plate mounted on an outer surface of the holder; and
an external terminal coupled to a second side of the connection plate.

2. The battery module as claimed in claim 1, wherein the plurality of battery cells are electrically connected to each other through bus bars.

3. The battery module as claimed in claim 1, wherein:
the electrode tab includes a negative electrode tab and a positive electrode tab, and
the connection plate includes a first connection plate electrically connected to the negative electrode tab and a second connection plate electrically connected to the positive electrode tab.

4. The battery module as claimed in claim 3, wherein a distance between the first connection plate and the second connection plate is 5.0 mm or greater.

5. The battery module as claimed in claim 3, wherein the connection plate has a width of 10 mm or greater.

6. The battery module as claimed in claim 3, wherein the connection plate has a thickness in a range of 0.3 mm to 0.5 mm.

7. The battery module as claimed in claim 3, wherein the first connection plate or the second connection plate includes a fuse part.

8. The battery module as claimed in claim 7, wherein the fuse part has a width in a range of 15% to 20% of a width of the connection plate.

9. The battery module as claimed in claim 1, wherein the second side of the connection plate is coupled to the external terminal using a bolt.

10. The battery module as claimed in claim 1, wherein the second side of the connection plate includes a bent portion.

11. The battery module as claimed in claim 1, wherein:
the holder includes a holder case in which the plurality of battery cells are aligned, and a holder cover coupled to the holder case and covering first surfaces of the plurality of battery cells,
the first side of the connection plate is electrically connected to the electrode tab of at least one of the plurality of battery cells from an outer surface of the holder case, and
the connection plate is mounted on the outer surface of the holder cover.

12. The battery module as claimed in claim 11, wherein:
the outer surface of the holder cover includes guide portions, and
the connection plate is mounted between the guide portions.

13. The battery module as claimed in claim 11, wherein the holder cover includes a plurality of ribs downwardly extending from an inner surface of the holder cover, the plurality of ribs being inserted between each of the plurality of battery cells.

14. The battery module as claimed in claim 13, wherein each of the plurality of ribs has a thickness in a range of 10% to 15% of a thickness of each of the plurality of battery cells.
